(19) United States
(12) Patent Application Publication
(10) Pub. No.: US 2022/0357976 A1
(43) Pub. Date: Nov. 10, 2022

(54) INFORMATION PROCESSING APPARATUS, INFORMATION PROCESSING METHOD, AND COMPUTER-READABLE RECORDING MEDIUM STORING INFORMATION PROCESSING PROGRAM

(71) Applicant: FUJITSU LIMITED, Kawasaki-shi (JP)

(72) Inventors: KENICHIRO TAKEDA, Yokohama (JP); Juntaro Minezaki, Chofu (JP)

(73) Assignee: FUJITSU LIMITED, Kawasaki-shi (JP)

(21) Appl. No.: 17/872,040

(22) Filed: Jul. 25, 2022

Related U.S. Application Data
(63) Continuation of application No. PCT/JP2020/010362, filed on Mar. 10, 2020.

(51) Int. Cl. G06F 9/455

(52) U.S. Cl. CPC G06F 9/45558; G06F 2009/45591; G06F 2009/45579

(57) ABSTRACT

An information processing apparatus includes: a memory; and a processor coupled to the memory and configured to: execute an operating system; manage an operation of the information processing apparatus; issue, on the basis of detection of connection of a device, an acquisition instruction to acquire device information of the device; acquire, while the operating system is being executed, the device information from the device on the basis of the acquisition instruction; and notify the acquired device information.

### CROSS-REFERENCE TO RELATED APPLICATION

This application is a continuation application of International Application PCT/JP2020/010362 filed on Mar. 10, 2020 and designated the U.S., the entire contents of which are incorporated herein by reference.

### FIELD

The embodiments discussed herein are related to an information processing apparatus, an information processing method, and an information processing program.

### BACKGROUND

Information processing apparatuses such as servers used in large-scale systems such as core systems or large-scale databases are needed to satisfy requirements such as high reliability, high availability, and high load processing. For example, this type of information processing apparatus has a hot-add function for connecting an input/output (I/O) device such as a peripheral component interconnect express (PCIe) card without powering down the system. In the case of acquiring device information of the I/O device by operating a basic input output system (BIOS), when the connection of the I/O device is detected, the information processing apparatus stops an operation of an operating system (OS), acquires the device information of the I/O device by the BIOS, and then resumes the operation of the OS.

Japanese Laid-open Patent Publication No. 2017-16514 is disclosed as related art.

### SUMMARY

According to an aspect of the embodiments, an information processing apparatus includes: a memory; and a processor coupled to the memory and configured to: execute an operating system; manage an operation of the information processing apparatus; issue, on the basis of detection of connection of a device, an acquisition instruction to acquire device information of the device; acquire, while the operating system is being executed, the device information from the device on the basis of the acquisition instruction; and notify the acquired device information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of an information processing apparatus according to an embodiment;

FIG. 2 is a sequence diagram illustrating an example of an operation of the information processing apparatus of FIG. 1;

FIG. 3 is a block diagram illustrating an example of an information processing apparatus according to another embodiment;

FIG. 4 is an explanatory diagram illustrating an outline of processing when a peripheral component interconnect express (PCIe) card is hot-added to a server in the server of FIG. 3;

FIG. 5 is a sequence diagram illustrating an example of the processing when the PCIe card is hot-added to the server in the server of FIG. 3;

FIG. 6 is a sequence diagram illustrating continuation of FIG. 5;

FIG. 7 is an explanatory diagram illustrating an example (comparative example) of processing when the PCIe card is hot-added to a server that does not use a guest mini basic input output system (BIOS) control unit and a guest mini BIOS; and

FIG. 8 is an explanatory diagram illustrating another example (comparative example) of the processing when the PCIe card is hot-added to the server that does not use the guest mini BIOS control unit and the guest mini BIOS.

### DESCRIPTION OF EMBODIMENTS

However, for the I/O device added by hot add, in the case of stopping the OS and operating the BIOS in order to recognize the device information, a system operation of a business application and the like by the information processing apparatus is stopped while the BIOS is operating. Thus, there is a risk of affecting business. Therefore, it is difficult to acquire the device information of the I/O device added by the hot add without affecting the business.

In one aspect, it is an object of embodiments to acquire device information of a device added to an information processing apparatus without stopping a system operation.

Hereinafter, embodiments will be described with reference to the drawings.

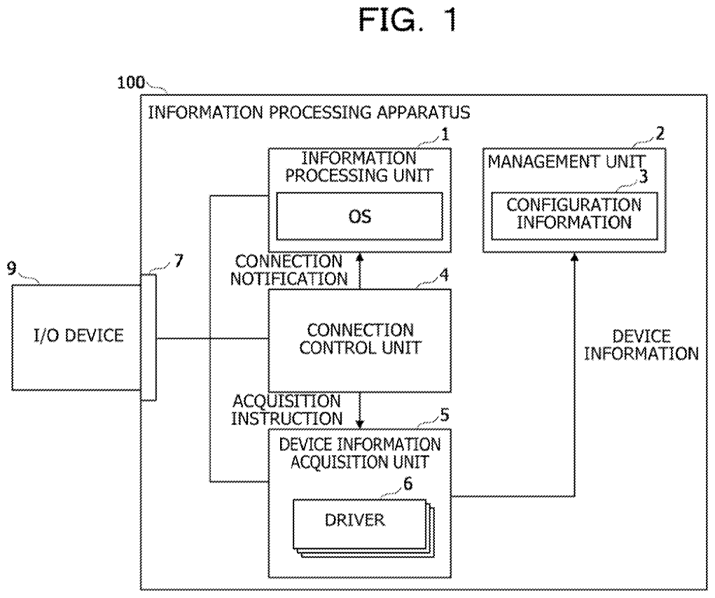

FIG. 1 illustrates an example of an information processing apparatus according to an embodiment. An information processing apparatus 100 illustrated in FIG. 1 is, for example, a server, and includes an information processing unit 1, a management unit 2, a connection control unit 4, a device information acquisition unit 5, and a connector 7 to which a device 9 is detachably connected.

The information processing unit 1 is, for example, a processor such as a central processing unit (CPU), and executes an operating system OS and an application (not illustrated). In the following, the operating system OS is also simply referred to as an OS. The management unit 2 is, for example, a baseboard management controller (BMC), and manages an operation of the entire information processing apparatus 100 including the information processing unit 1, and includes a storage unit that holds configuration information 3 indicating a system configuration of the information processing apparatus 100. The configuration information 3 held in the storage unit may be displayed on a display device connected to the information processing apparatus 100 on the basis of a request from the outside of the information processing apparatus 100.

The connection control unit 4 issues an acquisition instruction for acquiring device information of the device 9 to the device information acquisition unit 5 on the basis of detection of connection of the device 9 to the connector 7. For example, the connection control unit 4 detects the connection of the device 9 by receiving an interrupt generated by the connection of the device 9 to the connector 7. Although not particularly limited, the device 9 is an expansion card (I/O device) such as a peripheral component interconnect express (PCIe) card, and may be inserted into or removed from the connector 7 during an operation of the information processing apparatus 100.

The device information acquisition unit 5 acquires, during execution of the OS, device information from the device 9 whose connection to the connector 7 is detected, on the basis of an acquisition instruction from the connection control unit 4, and notifies the management unit 2 of the acquired device information. For example, on the basis of the acquisition instruction, the device information acquisition unit 5 starts a driver 6 of the device 9 whose connection is detected. The started driver 6 issues a command to acquire the device information to the device 9, and acquires the device information. By preparing drivers of various devices 9 that may be connected to the connector 7 in the device information acquisition unit 5 in advance, the device information may be acquired from the device 9 whose connection to the connector 7 is detected, without using a guest mini basic input output system (BIOS) exclusively operating with respect to the OS.

The device information notified to the management unit 2 is stored in the storage unit as the configuration information 3. With this configuration, the information processing apparatus 100 may acquire the device information of the device 9 newly connected to the connector 7, for example, without stopping the OS and a business application being executed by the information processing unit 1. Then, the information processing apparatus 100 may display the acquired device information on the display device as network inventory information.

The connection control unit 4 notifies the OS of the connection of the device 9 after the device information acquisition unit 5 acquires the device information. The OS that received the notification executes recognition processing of recognizing the device 9, recognizes the device 9, and then starts access of the device 9. Since the device information is acquired by the device information acquisition unit 5 in parallel with the operation of the OS, the OS does not have to stop a system operation of the business application and the like and switch the operation to the BIOS in order to acquire the device information. Therefore, the information processing apparatus 100 may acquire the device information of the newly added device 9 and start access of the device 9 without affecting the system operation.

Note that the connection control unit 4 may start the stopped device information acquisition unit 5 on the basis of the detection of the connection of the device 9, issue the acquisition instruction to the started device information acquisition unit 5, and acquire the device information. Furthermore, the connection control unit 4 may end the device information acquisition unit 5 on the basis of completion of the notification of the device information to the management unit 2 by the device information acquisition unit 5.

By operating the device information acquisition unit 5 only when acquiring the device information, it is possible to reduce power consumption of the information processing apparatus 100 as compared with a case where the device information acquisition unit 5 is operated at all times. Furthermore, in a case where the device information acquisition unit 5 is implemented by software, by operating the device information acquisition unit 5 only when acquiring the device information, it is possible to reduce a load applied to the information processing unit 1 or the like that executes a program that implements the device information acquisition unit 5.

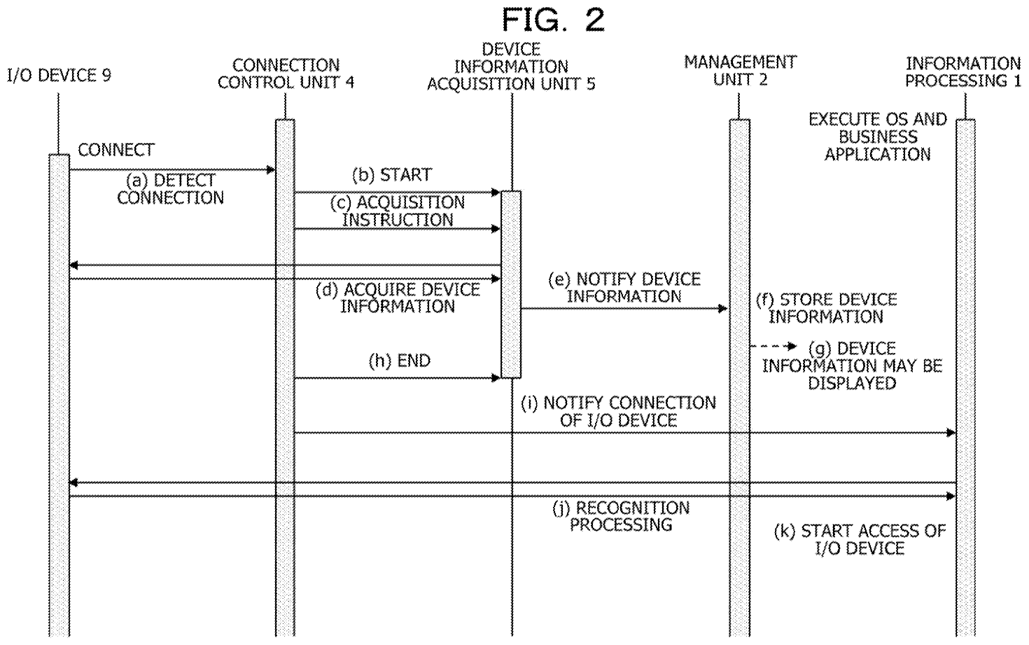

FIG. 2 illustrates an example of an operation of the information processing apparatus 100 of FIG. 1. FIG. 2 illustrates an example of an information processing method by the information processing apparatus 100 and an example of processing by an information processing program executed by the information processing apparatus 100. Note that, in an initial state of FIG. 2, the connection control unit 4, the management unit 2, and the information processing unit 1 are in operation. For example, the information processing unit 1 executes the OS and a business application.

When the device 9 is connected to the connector 7, the connection control unit 4 detects the connection of the device 9 and starts the device information acquisition unit 5 ((a) and (b) of FIG. 2). Furthermore, the connection control unit 4 issues an acquisition instruction for acquiring device information of the device 9 to the started device information acquisition unit 5 ((c) of FIG. 2).

During execution of the OS and the business application by the information processing unit 1, the device information acquisition unit 5 acquires, on the basis of the acquisition instruction from the connection control unit 4, the device information from the device 9 whose connection to the connector 7 is detected ((d) of FIG. 2). The device information acquisition unit 5 notifies the management unit 2 of the acquired device information ((e) of FIG. 2). The management unit 2 stores the device information notified from the device information acquisition unit 5 in the storage unit as the configuration information 3 ((f) of FIG. 2). With this configuration, the information processing apparatus 100 may display the device information of the device 9 connected to the connector 7 on a display device ((g) of FIG. 2).

The connection control unit 4 ends the device information acquisition unit 5 after completion of the notification of the device information to the management unit 2 by the device information acquisition unit 5 ((h) of FIG. 2). The connection control unit 4 notifies the OS of the connection of the device 9 after the device information acquisition unit 5 acquires the device information ((i) of FIG. 2). The OS executes recognition processing of recognizing the device 9 on the basis of the notification from the connection control unit 4 ((j) of FIG. 2). Then, after recognizing the device 9, the OS starts access of the device 9 ((k) of FIG. 2).

As described above, in the embodiment illustrated in FIGS. 1 and 2, for example, the information processing apparatus 100 may acquire the device information of the device 9 connected to the connector 7 without stopping the OS and the business application being executed by the information processing unit 1. With this configuration, the device information of the device 9 newly connected to the information processing apparatus 100 may be displayed on a display device as network inventory information without stopping the OS and the business application being executed by the information processing unit 1.

By operating the device information acquisition unit 5 only when acquiring the device information, it is possible to reduce power consumption of the information processing apparatus 100 as compared with a case where the device information acquisition unit 5 is operated at all times. Furthermore, in a case where the device information acquisition unit 5 is implemented by software, by operating the device information acquisition unit 5 only when acquiring the device information, it is possible to reduce a load applied to the information processing unit 1 or the like that executes a program that implements the device information acquisition unit 5.

Since the device information of the newly added device 9 may be acquired while the OS and the application are being executed, the information processing apparatus 100 may start access of the newly added device 9 without interrupting the OS and the business application. By preparing a driver of the device 9 that may be connected to the connector 7 in the device information acquisition unit 5 in advance, the device information may be acquired from the device 9 whose connection to the connector 7 is detected, without using a BIOS exclusively operating with respect to the OS.

Therefore, a system administrator who manages the information processing apparatus 100 may manage information regarding the added device 9 without causing a business stop, reduce downtime of the information processing apparatus 100, and improve availability of the system.

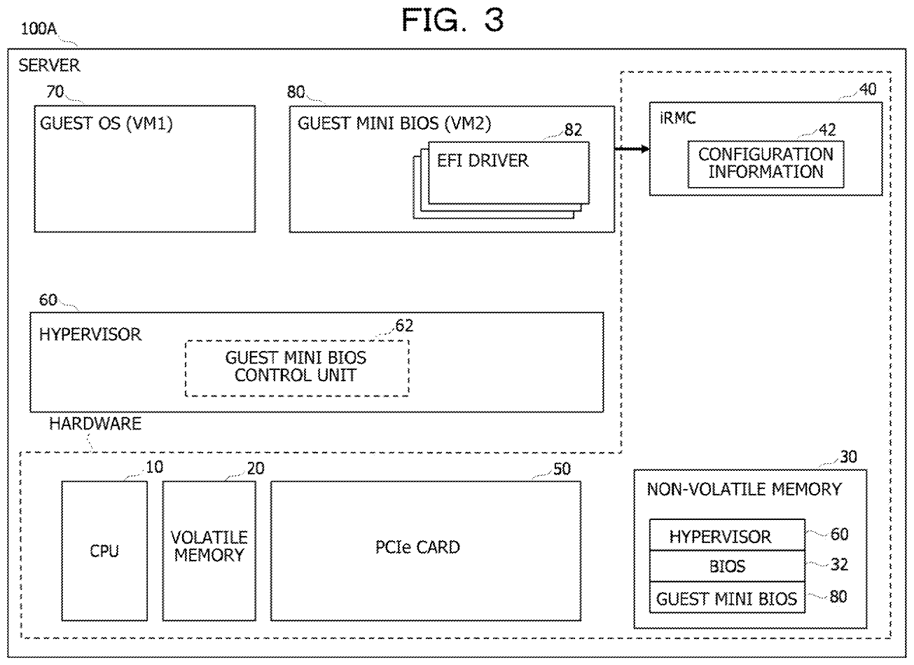

FIG. 3 illustrates an example of an information processing apparatus according to another embodiment. Detailed description of elements similar to those in FIG. 1 will be omitted. A server 100A illustrated in FIG. 3 includes, as hardware, a CPU 10, a volatile memory 20, a non-volatile memory 30, an integrated remote management controller (iRMC) 40, and a PCIe card 50. Although not particularly limited, the server 100A is, for example, an intel architecture (IA) server on which an OS such as Windows (registered trademark) or Linux (registered trademark) operates.

The server 100A includes, as software, a hypervisor 60, a guest OS 70, and a guest mini BIOS 80 that are implemented by a program executed by the CPU 10. The hypervisor 60 includes a guest mini BIOS control unit 62. In the following, a function of the guest mini BIOS control unit 62 may be described as a function of the hypervisor 60, and the function of the hypervisor 60 may be described as the function of the guest mini BIOS control unit 62. The server 100A is an example of the information processing apparatus. Note that a hardware configuration and a software configuration of the server 100A are not limited to those of FIG. 3.

The CPU 10 implements the functions of the hypervisor 60, the guest OS 70, and the guest mini BIOS 80 by executing the information processing program, and also executes various application programs such as business applications. The CPU 10 is an example of the information processing unit. The volatile memory 20 is, for example, a memory module including a synchronous dynamic random access memory (SDRAM), and various programs stored in the non-volatile memory 30 are expanded, and executed by the CPU 10.

The PCIe card 50 is an example of the device, and is detachably connected to the server 100A via a card slot (not illustrated). Note that the server 100A may include a plurality of card slots on a motherboard. The server 100A has a hot-add function that enables addition of the PCIe card 50 while the guest OS 70 or the like is operated. Note that another I/O device other than the PCIe card 50 may be added to the server 100A by using the hot-add function.

The non-volatile memory 30 has a region in which a program of the hypervisor 60, a program of the BIOS 32 mounted on a virtual machine together with a guest OS, a program of the guest mini BIOS 80, and the like are stored. The non-volatile memory 30 is, for example, a flash memory.

The iRMC 40 includes functions of a BMC and an intelligent platform management interface (IPMI), monitors the CPU 10, a bus, a fan, a temperature sensor, a voltage, and the like, and accepts control from a remote location. The iRMC 40 includes a storage unit that holds configuration information 42 indicating a system configuration of the server 100A. The configuration information 42 includes card information of the PCIe card 50 connected to the server 100A, and the like. The iRMC 40 is an example of the management unit that manages an operation of the server 100A.

Here, examples of the card information include a vendor name of the PCIe card 50, a device name, a media access control (MAC) address of a network interface card (NIC), and a worldwide name (WWN) of a fiber channel card. These pieces of card information stored in the storage unit as the configuration information 42 may be displayed on a management screen of a web browser or the like of a display device as network inventory information by the iRMC 40. A system administrator or the like who manages the server 100A may grasp the card information of the PCIe card 50 or the like connected to the server 100A from the network inventory information displayed on the management screen of the web browser or the like.

The hypervisor 60 is an example of a virtual machine monitor, and is located on the midway between the hardware such as the CPU 10 and the volatile memory 20 and the software such as the BIOS 32 and the guest OS 70. The hypervisor 60 implements dynamic addition and deletion of the hardware on the system implemented by the server 100A by virtualizing the hardware and making it look like the software as virtual hardware.

The guest mini BIOS control unit 62 has a function of receiving an interrupt issued from the PCIe card 50 at the time of hot add and a function of notifying the guest OS 70 to which the PCIe card 50 is added by hot add of a hot-add event. The guest mini BIOS control unit 62 has a function of loading the guest OS 70 and constructing a virtual machine VM1 and a function of controlling start and end of the guest OS 70.

Furthermore, the guest mini BIOS control unit 62 has a function of controlling allocation and deletion of hardware resources such as the PCIe card 50 with respect to the guest OS 70. The guest mini BIOS control unit 62 has a function of loading the guest mini BIOS 80 and constructing a virtual machine VM2 and a function of controlling start and end of the guest mini BIOS 80. Moreover, the guest mini BIOS control unit 62 secures resources such as the CPU and the memory used in the guest mini BIOS 80 when the server 100A is started. The guest mini BIOS control unit 62 is an example of the connection control unit. By constructing the virtual machines VM1 and VM2 by the hypervisor 60 (guest mini BIOS control unit 62), a parallel operation of the guest OS 70 and the guest mini BIOS 80 may be easily implemented.

The guest mini BIOS 80 is a BIOS that is dynamically loaded into the server 100A to acquire card information of the hot-added PCIe card 50. The guest mini BIOS 80 may be executed in parallel with the guest OS 70 on the basis of the control by the guest mini BIOS control unit 62. The guest mini BIOS 80 includes an extensible firmware interface (EFI) driver 82 for various PCIe cards 50 that may be connected to the card slot. The guest mini BIOS 80 is an example of the device information acquisition unit.

In the guest mini BIOS 80, a function of recognizing the PCIe card 50 and a function to an extent that a command of a systems management architecture for server hardware command line protocol (SMASH CLP) which is a mechanism to acquire card information may be issued only need to be mounted. For example, the guest mini BIOS 80 does not have to have a full function like a normal BIOS. In the following, the command of the SMASH CLP will be referred to as a CLP command.

Note that, in FIG. 3, an example is indicated in which the virtual machine VM1 that executes one guest OS 70 and the virtual machine VM2 that executes one guest mini BIOS 80 are generated in the server 100A. However, the number of virtual machines generated is not limited to that in FIG. 3. For example, one guest mini BIOS 80 (virtual machine VM2) may be started with respective to a plurality of the guest OSs 70 (virtual machines VM1). In this case, the guest mini BIOS 80 is provided in common to the plurality of guest OSs 70, and has a function of being able to execute card information acquisition processing at the time of hot add of a plurality of the PCIe cards 50 and the like in parallel.

With this configuration, hardware resources such as the CPU and the memory may be used more effectively than in a case where the guest mini BIOS 80 is started for each guest OS 70. Note that, in a case where one guest mini BIOS 80 (virtual machine VM2) is allocated to a predetermined number of the guest OSs 70 (virtual machines VM1), the guest mini BIOS 80 may be resident in the server 100A.

In a case where the CPU 10 includes a plurality of CPU cores, or in a case where the server 100A includes a plurality of the CPUs 10, CPU resources may be allocated as indicated below.

### Allocation Example 1: Method of Occupying CPU Resources

When the server 100A is started, the guest mini BIOS control unit 62 allocates at least one CPU core (or CPU, the same applies hereinafter) exclusively for the guest mini BIOS 80. The CPU core exclusively for the guest mini BIOS 80 is not used for the guest OS 70, and the like. With this configuration, it is possible to suppress all CPU cores from being allocated for the guest OS 70, and to suppress a failure such that the guest mini BIOS 80 is not started at the time of hot add. Note that the CPU core allocated for the guest mini BIOS 80 may be shared by a plurality of the guest mini BIOSs 80.

Furthermore, since it is not needed to execute search processing or the like of searching for the CPU core allocated for the guest mini BIOS 80 at the time of hot add, the guest mini BIOS 80 may be started at high speed. Note that, in many cases, a current server system includes about tens to hundreds of CPU cores, and even when one CPU core is occupied for the guest mini BIOS 80, it has little effect on performance of the entire server system or availability of an operation.

### Allocation Example 2: Method of Not Occupying CPU Resources

When the guest mini BIOS 80 is started, at least one of CPU cores to which the guest OS 70 is not allocated is dynamically allocated exclusively for the guest mini BIOS 80. Note that, in a case where all CPU resources of the server system have been allocated to the guest OS 70, the guest mini BIOS 80 may not be started. In order to suppress that the guest mini BIOS 80 may not be started, any one of the CPU cores allocated to the guest OS 70 is temporarily released from the guest OS 70 and allocated to the guest mini BIOS 80.

For example, in a small-scale server system or the like, an operation may be performed during normal business by allocating CPU resources to the guest OS 70 as much as possible to improve resource use efficiency. In such an operation, the CPU resources may be temporarily released during maintenance or the like to allocate a CPU core for the guest mini BIOS 80.

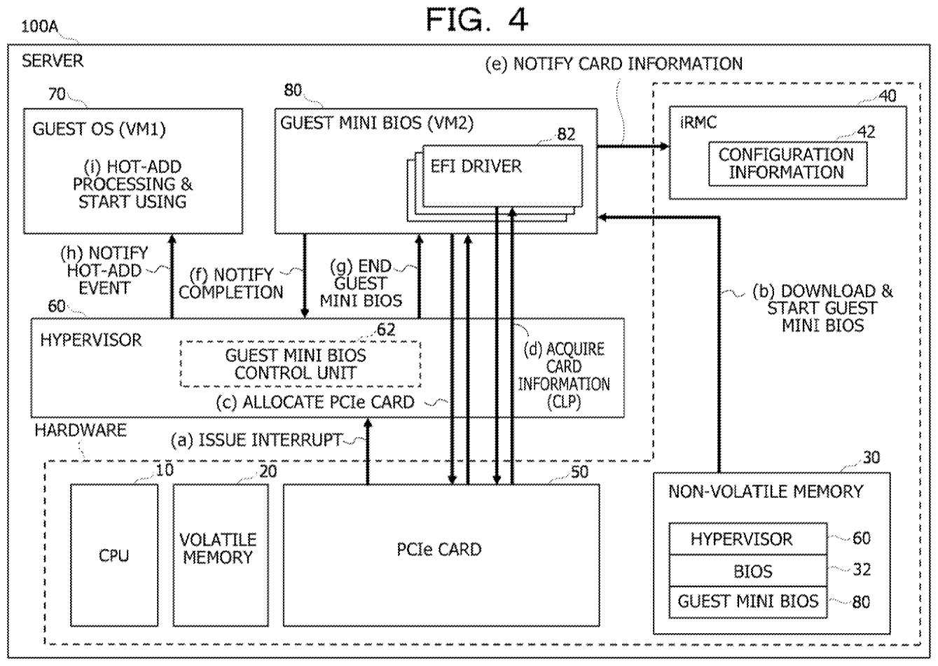

FIG. 4 illustrates an outline of processing when the PCIe card 50 is hot-added to the server 100A in the server 100A of FIG. 3. When the PCIe card 50 is hot-added to the server 100A, an interrupt notifying the hot add is issued ((a) of FIG. 4). The guest mini BIOS control unit 62 that detects the interrupt of the hot add downloads the guest mini BIOS 80 from the non-volatile memory 30 and starts the guest mini BIOS 80 ((b) of FIG. 4).

Here, the guest mini BIOS 80 is loaded and expanded from the non-volatile memory 30 onto the volatile memory 20. Note that the guest mini BIOS 80 may be resident in the server 100A. In this case, a download time from the non-volatile memory 30 may be eliminated, and a time until the guest mini BIOS 80 is started may be shortened.

When starting the guest mini BIOS 80, the guest mini BIOS control unit 62 allocates the hot-added PCIe card 50 so that the guest mini BIOS 80 may recognize the hot-added PCIe card 50 ((c) of FIG. 4). The guest mini BIOS 80 starts the EFI driver 82 of the hot-added PCIe card 50. The EFI driver 82 issues a CLP command to the PCIe card 50 to acquire card information ((d) of FIG. 4). Note that a protocol other than the CLP may be used to acquire the card information from the PCIe card 50.

The guest mini BIOS 80 notifies the iRMC 40 of the acquired card information ((e) of FIG. 4). The iRMC 40 holds the notified card information as the configuration information 42. The guest mini BIOS 80 notifies the guest mini BIOS control unit 62 of completion of acquisition of the card information ((f) of FIG. 4). The guest mini BIOS control unit 62 ends the guest mini BIOS 80 on the basis of the notification of the completion from the guest mini BIOS 80 ((g) of FIG. 4).

The guest mini BIOS control unit 62 notifies the guest OS 70 of a hot-add event ((h) of FIG. 4). On the basis of the notification from the guest mini BIOS control unit 62, the guest OS 70 performs hot-add processing of recognizing the PCIe card 50 and starts using the PCIe card 50 ((i) of FIG. 4).

In the above processing flow, the guest mini BIOS control unit 62 starts the guest mini BIOS 80 after detecting the interrupt of the hot add, and causes the guest mini BIOS 80 to acquire the card information and to notify the iRMC 40 of the card information. Then, after the series of the processing of acquiring the card information is executed, the guest mini BIOS control unit 62 notifies the guest OS 70 of the hot-add event.

With this configuration, the card information of the hot-added PCIe card 50 may be acquired without stopping the processing of the guest OS 70, for example, without stopping the business application, and may be notified to the iRMC 40. For example, a system administrator who manages the server 100A may manage the card information regarding the added PCIe card 50 without causing a business stop, reduce downtime of the server 100A, and improve availability of the server system.

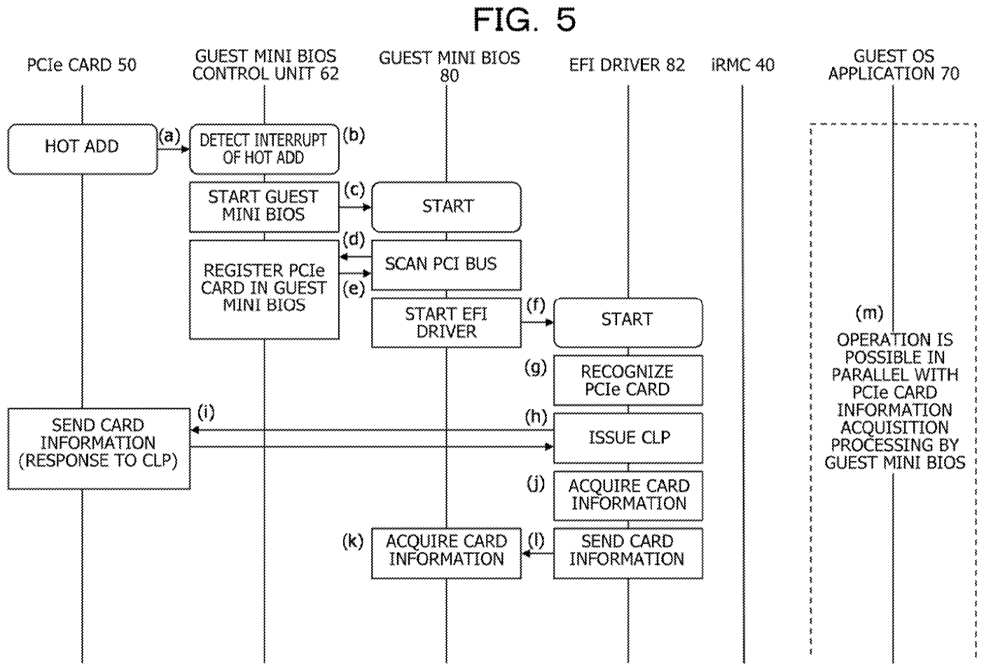

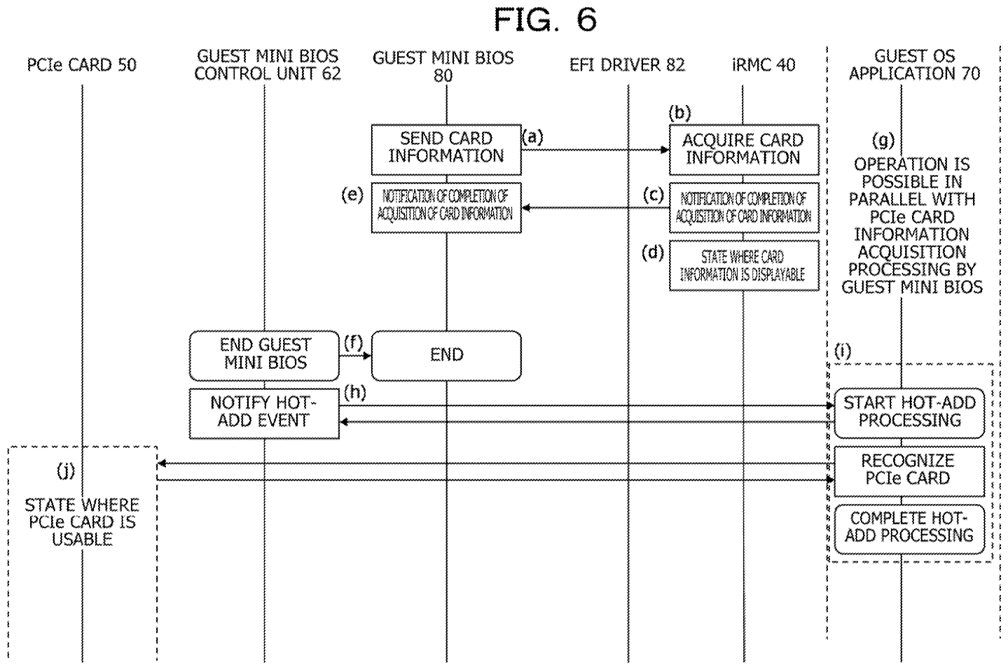

FIGS. 5 and 6 illustrate an example of the processing when the PCIe card 50 is hot-added to the server 100A in the server 100A of FIG. 3. Detailed description of processing similar to that in FIG. 4 will be omitted. FIGS. 5 and 6 illustrate an example of the information processing method by the server 100A. Furthermore, among operations illustrated in FIGS. 5 and 6, the operation of the guest mini BIOS control unit 62 and the operation of the guest mini BIOS 80 indicate examples of processing by the information processing program executed by the server 100A.

When the PCIe card 50 is hot-added to the server 100A, an interrupt notifying the hot add is issued ((a) of FIG. 5). The guest mini BIOS control unit 62 detects the interrupt of the hot add, and issues a start instruction to the guest mini BIOS 80 in order to start the guest mini BIOS 80 ((b) and (c) of FIG. 5). The start instruction of the guest mini BIOS 80 by the guest mini BIOS control unit 62 is an example of the acquisition instruction to acquire device information of the PCIe card 50. The started guest mini BIOS 80 scans a PCI bus through the guest mini BIOS control unit 62 ((d) of FIG. 5). The guest mini BIOS control unit 62 registers information indicating the hot-added PCIe card 50 in the guest mini BIOS 80 ((e) of FIG. 5).

Thereafter, the guest mini BIOS 80 starts the EFI driver 82 of the hot-added PCIe card 50 ((f) of FIG. 5). The EFI driver 82 recognizes the PCIe card 50 on the basis of a scan result of the PCI bus, and issues a CLP command to the PCIe card 50 ((g) and (h) of FIG. 5). The PCIe card 50 sends card information to the EFI driver 82 as a response to the CLP command ((i) of FIG. 5). Then, the EFI driver 82 acquires the card information of the hot-added PCIe card 50 ((j) of FIG. 5).

The EFI driver 82 sends the acquired card information to the guest mini BIOS 80, and the guest mini BIOS 80 acquires the card information ((k) and (I) of FIG. 5). Note that the guest OS 70 and various applications may operate during card information acquisition processing from when the PCIe card 50 is hot-added until the guest mini BIOS 80 acquires the card information ((m) of FIG. 5). Therefore, the card information of the hot-added PCIe card 50 may be acquired without stopping business being executed by the server 100A.

Next, in FIG. 6, the guest mini BIOS 80 sends the acquired card information to the iRMC 40 ((a) of FIG. 6). The iRMC 40 acquires the sent card information, and issues a notification of completion of acquisition of the card information ((b) and (c) of FIG. 6). For example, the acquired card information (for example, network inventory) may be displayed on a display device by the iRMC 40 ((d) of FIG. 6). The guest mini BIOS 80 receives the notification of completion of acquisition of the card information, and completes the card information acquisition processing ((e) of FIG. 6).

After the completion of the card information acquisition processing by the guest mini BIOS 80, the guest mini BIOS control unit 62 ends the guest mini BIOS 80 ((f) of FIG. 6). The guest OS 70 and various applications may also operate during the card information acquisition processing from when the iRMC 40 acquires the card information until the guest mini BIOS 80 ends ((g) of FIG. 6). For example, the card information of the hot-added PCIe card 50 may be notified to the iRMC 40 without stopping the business being executed by the server 100A.

Next, the guest mini BIOS control unit 62 notifies the guest OS 70 of a hot-add event ((h) of FIG. 6). On the basis of the notification from the guest mini BIOS control unit 62, the guest OS 70 starts hot-add processing of recognizing the PCIe card 50, and after recognizing the hot-added PCIe card 50, completes the hot-add processing ((i) of FIG. 6). After being recognized by the guest OS 70, the PCIe card 50 becomes usable ((j) of FIG. 6). Then, use of the PCIe card 50 by the application is started.

As illustrated in FIGS. 5 and 6, in this embodiment, the guest mini BIOS control unit 62 and the guest mini BIOS 80 may operate in parallel with the guest OS 70 and the application. Thus, the card information may be acquired without stopping the guest OS 70 and the application. Furthermore, the guest OS 70 may recognize the PCIe card 50 as before and execute the hot-add processing without adding a new function. Moreover, the card information acquisition processing may be automatically executed by the guest mini BIOS control unit 62 without interposing any user operation.

Note that the guest OS 70 temporarily stops execution of the business application and the like while the hot-add processing is being performed. However, this stopping period also occurs in the prior hot-add processing of the PCIe card 50 whose card information has been acquired by the BIOS, and hardly affects the business application and the like.

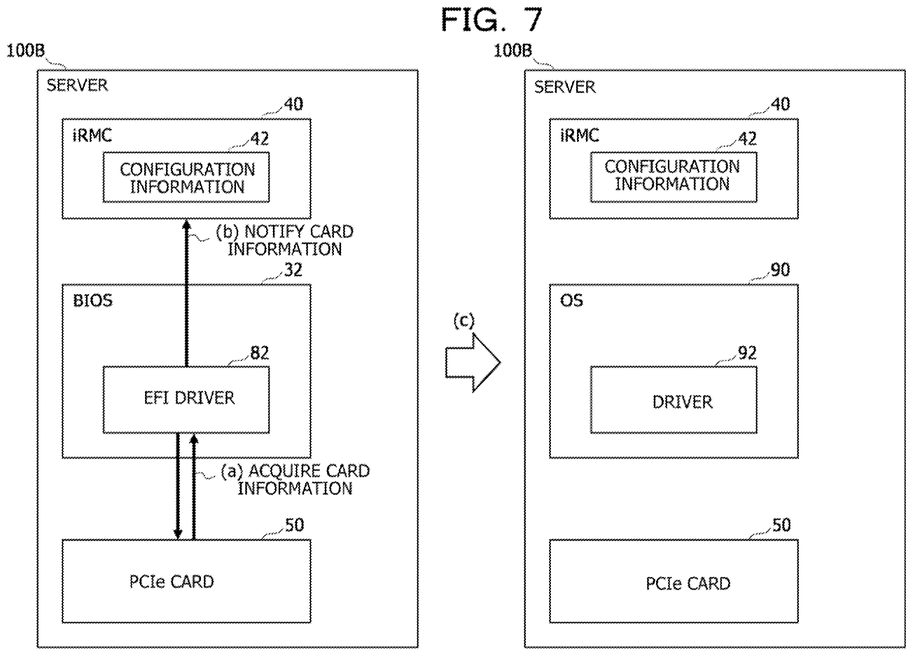

FIG. 7 illustrates an example (comparative example) of processing when the PCIe card 50 is hot-added to a server that does not use the guest mini BIOS control unit 62 and the guest mini BIOS 80. Elements similar to those in FIG. 3 are denoted by the same reference signs, and detailed description is omitted.

On the left side of FIG. 7, a server 100B loads a BIOS 32 into a system memory at power-on and starts the BIOS 32. An EFI driver 82 of the started BIOS 32 issues a CLP command to a PCIe card 50 connected to the server 100B to acquire card information of the PCIe card 50 ((a) of FIG. 7).

The BIOS 32 notifies an iRMC 40 of the information of the PCIe card 50 acquired by the CLP command ((b) of FIG. 7). The iRMC 40 holds the card information notified from the BIOS 32 as configuration information 42 (network inventory information). With this configuration, the iRMC 40 may display the network inventory information on a display device on the basis of the card information held as the configuration information.

After the server 100B is started, the BIOS 32 is unloaded from the system memory, and the control of the server 100B is taken over by an OS 90, as illustrated on the right side of FIG. 7 ((c) of FIG. 7). The control of the PCIe card 50 is also taken over from the EFI driver 82 of the BIOS 32 to a driver 92 in the OS 90.

Note that, unlike the EFI driver 82 in the BIOS 32, the driver 92 in the OS 90 does not have a mechanism to acquire the card information of the PCIe card 50 by the CLP command. Therefore, the card information of the PCIe card 50 displayed on the display device by the iRMC 40 after the server 100A is started is only card information acquired by the BIOS 32 at power-on of the server 100B and stored in the iRMC 40. Since the card information (network inventory) of the PCIe card 50 hot-added during an operation of the OS 90 is not included in the configuration information 42 of the iRMC 40, the card information is not displayed on the display device.

Since the BIOS 32 and the OS 90 operate exclusively, it is not possible to acquire the card information of the PCIe card 50 hot-added by the BIOS 32 while the OS 90 is in operation. Thus, the card information of the PCIe card 50 hot-added during the operation of the OS 90 is acquired by restarting the server 100B, starting the BIOS 32, and performing the procedures (a) and (b) of FIG. 7, and is notified to the iRMC 40. Note that, since the operation of the OS 90 is stopped while the BIOS 32 is in operation, for example, there is a risk that the execution of the business application is also stopped and the system operation is affected. With this configuration, there is a risk that the following failures are caused.

For example, in a case where the server system performs continuous operation for 24 hours and 365 days, restart of the server system may not be easily performed. Furthermore, in maintenance of the I/O device, or the like, it is not permitted to interrupt the OS 90 and the business application at a time level that affects the business.

Furthermore, in a case where the server system executes high-throughput and low-latency I/O processing at all times, the OS 90 may not be permitted to be interrupted when a configuration of the I/O device is changed, or the like. For example, an interruption of the OS 90 for a period of time that affects the business is not permitted. Furthermore, when the I/O device is accessed from outside the server system, a response time is not permitted to exceed a timeout time due to an interruption of the OS 90.

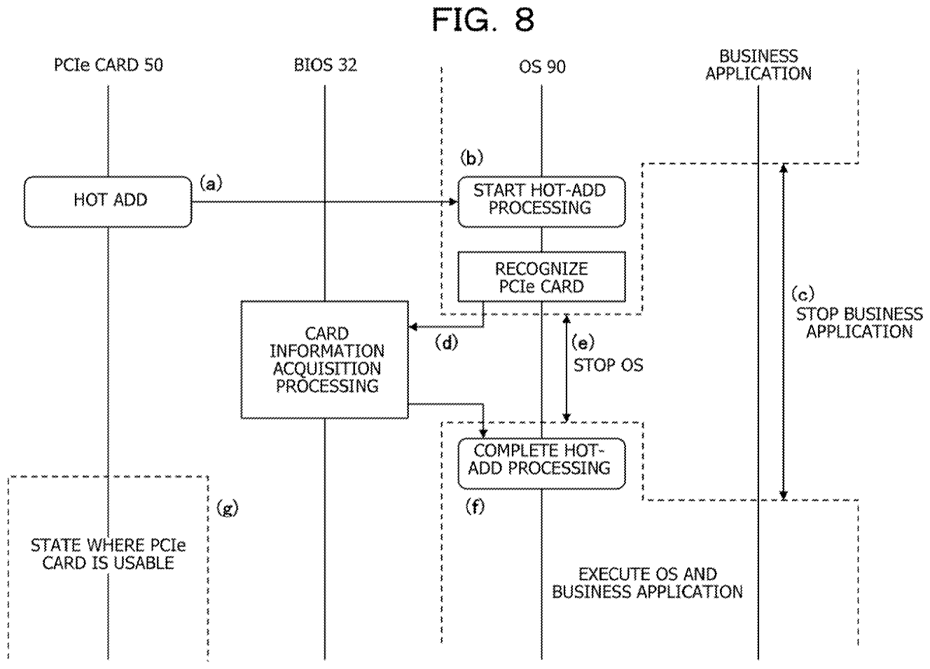

FIG. 8 illustrates another example (comparative example) of the processing when the PCIe card 50 is hot-added to the server that does not use the guest mini BIOS control unit 62 and the guest mini BIOS 80.

First, when the PCIe card 50 is hot-added to the server 100A, an interrupt notifying the hot add is issued ((a) of FIG. 8). The OS 90 detects the interrupt of the hot add, and starts the hot-add processing ((b) of FIG. 8). Note that, before the PCIe card 50 is hot-added, the server executes the OS 90 and the business application. The business application is stopped from the start to completion of the hot-add processing of the OS 90 ((c) of FIG. 8).

The OS 90 recognizes the hot-added PCIe card 50, and causes the BIOS 32 to execute the card information acquisition processing ((d) of FIG. 8). For example, an operating state of the OS 90 is switched to an operating state of the BIOS 32. Here, since the OS 90 does not have a function of acquiring the card information from the PCIe card 50, the card information is acquired by the EFI driver 82 of the BIOS 32. Since the OS 90 and the BIOS 32 are executed exclusively, the OS 90 stops operating while the BIOS 32 is operating ((e) of FIG. 8).

Then, after the acquisition of the card information by the BIOS 32, the control returns to the OS 90, and the OS 90 resumes the operation and completes the hot-add processing ((f) of FIG. 8). By the completion of the hot-add processing, the PCIe card 50 becomes usable ((g) of FIG. 8). Thereafter, the business application resumes the operation, and business processing using the PCIe card 50 is executed.

In the example illustrated in FIG. 8, since the hot-add processing includes the card information acquisition processing by the BIOS 32, the period of the hot-add processing is longer than that of FIG. 6. With this configuration, there is a risk that the stopping periods of the OS 90 and the business application are also extended, which may affect the system operation.

Note that, in a case where the OS 90 is provided with a card information acquisition function, it is needed to develop a function such as a driver for acquiring the card information for each OS 90. For example, in an IA system, hardware information including I/O information of a PCIe card or the like is acquired by a BIOS when the system is started, and notified to an OS. Thus, in a case where a new function such as the card information acquisition function is added, it is needed to develop a part to which the function is added for each OS 90, which is costly. Furthermore, there is a risk that versatility of the OS 90 is lost because availability of support for the function to be added is different for each OS 90.

As described above, also in the embodiment illustrated in FIGS. 3 to 6, effects similar to those in the embodiment illustrated in FIGS. 1 and 2 may be obtained. For example, the server 100A may acquire the card information of the hot-added PCIe card 50 without stopping the guest OS 70 and the business application. With this configuration, the device information of the PCIe card 50 hot-added to the server 100A may be displayed on the display device as network inventory information without stopping the guest OS 70 and the business application. Furthermore, the server 100A may start access of the newly added PCIe card 50 without interrupting the guest OS 70 and the business application.

Moreover, in the embodiment illustrated in FIGS. 3 to 6, the guest mini BIOS 80 may be operated on the virtual machine by providing the hypervisor 60 with the function of the guest mini BIOS control unit 62. With this configuration, by constructing the virtual machines VM1 and VM2 by the hypervisor 60 (guest mini BIOS control unit 62), a parallel operation of the guest OS 70 and the guest mini BIOS 80 may be easily implemented. Then, after an interrupt of hot add is issued and before a hot-add event is notified to the guest OS 70, the card information acquisition processing may be completed by the guest mini BIOS control unit 62.

Note that the embodiments described above are highly effective in the case of being applied to a large-scale system in that the embodiments do not involve a business stop, but the embodiments do not limit the field of application. Even in a small-scale system or a system for personal use, it is beneficial also from a viewpoint of improving availability of the system that the business stop is not involved, no additional function is needed for the OS, and no user operation is needed.

From the detailed description above, characteristics and advantages of the embodiments will become apparent. This intends that claims cover the characteristics and advantages of the embodiments described above without departing from the spirit and the scope of the claims. Furthermore, any person having ordinary knowledge in the technical field should be able to easily come up with various improvements and modifications. Therefore, there is no intention to limit the scope of the inventive embodiments to those described above, and the scope of the inventive embodiments may rely on appropriate improvements and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
execute an operating system;
manage an operation of the information processing apparatus;
issue, on the basis of detection of connection of a device, an acquisition instruction to acquire device information of the device;
acquire, while the operating system is being executed, the device information from the device on the basis of the acquisition instruction; and
notify the acquired device information.

2. The information processing apparatus according to claim 1, wherein
the processor
starts an acquisition of the device information on the basis of the detection of the connection of the device,
issues the acquisition instruction,
ends the acquisition of the device information on the basis of completion of the notification of the device information, and
notifies the operating system of the connection of the device.

3. The information processing apparatus according to claim 1, wherein
on the basis of the notification of the connection of the device, the operating system executes recognition processing of the device, and starts access of the device.

4. The information processing apparatus according to claim 1, wherein
the processor is included in a virtual machine monitor generated on the information processing apparatus,
the operating system is executed on a first virtual machine generated on the information processing apparatus, and
a function of the processor is implemented by a second virtual machine generated on the information processing apparatus.

5. The information processing apparatus according to claim 4, wherein
a plurality of the first virtual machines each executes the operating systems is generated, and
the function of the processor implemented by the second virtual machine is used in common by the plurality of first virtual machines.

6. The information processing apparatus according to claim 1, wherein
on the basis of the acquisition instruction, the processor starts a driver of the device whose connection is detected, and
the started driver issues a command to acquire the device information to the device.

7. An information processing method comprising:
executing an operating system;
managing an operation of an information processing apparatus;
issuing, on the basis of detection of connection of a device, an acquisition instruction to acquire device information of the device;
acquiring, while the operating system is being executed, the device information from the device on the basis of the acquisition instruction; and
notifying the acquired device information.

8. A non-transitory computer-readable recording medium storing an information processing program which causes a computer to execute a processing of:
executing an operating system;
managing an operation of an information processing apparatus;
issuing, on the basis of detection of connection of a device, an acquisition instruction to acquire device information of the device;
acquiring, while the operating system is being executed, the device information from the device on the basis of the acquisition instruction; and
notifying the acquired device information.
